(19) United States
(12) Patent Application Publication
(10) Pub. No.: US 2011/0174821 A1
(43) Pub. Date: Jul. 21, 2011

(54) SECURING ELEMENT FOR A CLOSING ELEMENT

(75) Inventor: Guido Endert, Leichlingen (DE)

(73) Assignee: CLIQLOC GMBH, KOLN (DE)

(21) Appl. No.: 12/994,464

(22) PCT Filed: May 27, 2009
(86) PCT No.: PCT/EP09/56488

§ 371 Date: Feb. 2, 2011

(30) Foreign Application Priority Data
May 27, 2008 (DE) 10 2008 025 429 0
May 27, 2008 (DE) 10 2008 025 430 4

(51) Int. Cl. B65D 45/00; B23P 19/04

(52) U.S. Cl. 220/315; 29/428

(57) ABSTRACT

The invention relates to a securing element (10) for a closing element (20), said closing element (20) having a center piece (21) which comprises an actuation zone (22), and holding means (23). The closing element (20) closes an opening (31) of a container (30) which has a longitudinal axis (34) in a first position (I) and releases the same in a second position (II), the holding means (23) being in positive fit with the container in the first position (I). The closing element (20) can be brought from the first into the second position (I, II) by the action of a pressure onto the actuation zone (22) in the direction of the container (30) so that the holding means (23) releases the form fit. In order to prevent any inadvertent exertion of pressure onto the actuation zone (22), the closing element (20) is arranged between the securing element (10) and the container (30) in the first position (I) and the securing element (10) has a passage (12) which is substantially arranged above the actuation zone (22), pressure being exertable onto the actuation zone (22) only through the passage (12).

### TECHNICAL FIELD

The invention is directed towards a securing element for a closing element, wherein the closing element is configured to have a centre piece, which comprises an actuation zone, and holding means, wherein the closing element in a first position closes an opening of a container which has a longitudinal axis and releases it in a second position, wherein in the first position the holding means enter into a form fit with the container and wherein the closing element can be brought from the first into the second position by a pressure acting on the actuation zone in the direction of the container so that the holding means release the form fit. The invention is further directed to a container having a securing element according to the invention and a method for opening a container.

### BACKGROUND

The closing element described above in combination with a container can form a can which, in colloquial language, is designated as a “click-clack” can or “clip-clap” can. This can is frequently used as a reclosable sweet packaging, the can usually being configured to be round.

The container, in this case, the can, has at least one lateral surface which provides counter-holding means for the requisite form fit with the closing element. The counter-holding means can, for example, be a projection or a groove.

The closing element comprises a centre piece having a holding means disposed in an approximately central actuation zone and on the centre piece. In relation to the first position, the centre piece has an inner surface which points towards the container and an outer surface which points away from the container. The holding means which marginally surround the centre piece in particular in the manner of a crenellation, are bent at an angle α towards the inner surface. In this case, the angle α is preferably somewhat greater than 90°. Each holding means is also bent at its end again towards the inner surface.

The closing element is preferably made of hard metal, in particular of metal or plastic but is nevertheless sufficiently elastic that it can adopt two different positions in the form of two secured positions. In the first position, the closure device closes the container with the closing element. The centre piece hereby covers the opening of the container. In this case, it is slightly curved away from the container in the direction of the longitudinal axis. When viewed from the inner surface of the centre piece, this corresponds to a concave curvature. Due to this curvature the holding means run approximately parallel to the side surface of the container which has the projection. In this case, the angled ends of the holding means form a form fit with the projection. Therefore, unlike other containers, in particular sweet cans, the container also normally remains closed when an attempt is made to open the container by pulling apart closing element and container. In the case of an excessive tensile force, the holding means can bend or break, whereby the closing element can be at least partially destroyed.

The container can be opened, on the other hand, if a pressure is applied only to the actuation zone in the direction of the longitudinal axis and towards the container. The centre piece undergoes an elastic deformation from one secured position into the other and curves in the direction of the container. When viewed from the inner surface of the centre piece, this corresponds to a convex curvature. In the course of the elastic deformation, the holding means move away from the container and release the projection. By this means the closing element can now be released from the container, easily and without any force, in particular without applying any tensile force.

If the container is to be closed again, the closing element is placed with the inner side to which the holding means point, on the container. In this case, the holding means are still at a slight distance from the projection. By means of pressure on the holding means, in particular perpendicular to the longitudinal axis, the centre piece moves from one secured position, corresponding to convex curvature when viewed from inside, into the other secured position, corresponding to concave curvature when viewed from inside, and the closing element enters into its first position again.

In practice, it has been shown that a container with such closing elements can easily be opened unintentionally. In this case, as described above, a pressure must be applied to the actuation zone. However, this can occur not only due to a user but also, for example in a narrow handbag, by other items exerting pressure on the actuation zone. By this means the container is opened in the handbag without the user desiring this or being aware of this and the contents, in particular sweets, fall out of the container and become distributed in the handbag.

### BRIEF SUMMARY

The invention provides a device and a method to prevent unintentional pressure on the actuation zone so that only a user can knowingly open the container. In this case, in particular the intentional opening of the container should be capable of being executed with the simplest possible movement, in particular with only one finger so that this is easy to use for weak and/or clumsy people.

According to the invention, it is provided that the closing element is disposed between the securing element and the container in the first position and the securing element has a passage which is substantially disposed above the actuation zone and a pressure can only be exerted on the actuation zone through the passage.

In this case, the securing element is preferably formed as an additional lid element which covers at least the outer surface of the centre piece. Usually the securing element will have the same, for example, rectangular or round shape as the centre piece. A random pressure such as is produced, for example, by a flat surface in a handbag now no longer acts on the closing element with the actuation zone but on the securing element. The securing element is selected to be sufficiently inelastic so that it does not transfer the pressure to the centre piece. By this means, a random opening of the container is largely avoided. In order that the container can still be opened despite the securing element, the securing element has a passage which is disposed substantially above the actuation zone, i.e. approximately centrally. A pressure can be exerted on the actuation zone through the passage and the container thus opened. For this, according to the invention exclusively a pressure in the direction of the actuation zone in the direction of the container is sufficient. That is to say that a user only needs to perform the same movement for opening the container as that without the securing element. The securing element is therefore without effect in relation to a desired opening of the container by a user. The securing element can be differently shaped towards its outer circumferential edge without its function being impaired. For example, an angular, flattened or round circumferential edge is possible.

It can advantageously be provided that the passage is configured to be long in the direction of the longitudinal axis. Hence, the wall thickness of the securing element should be as high as possible so that the passage acquires a long tunnel-like character. This avoids objects having a pointed corner from passing randomly through the passage and thus being able to exert an undesired pressure on the actuation zone.

Likewise, it is therefore less likely that an object passes randomly through the passage if the passage is of small spatial dimensions perpendicular to the longitudinal axis. The passage should therefore be made as narrow as possible. It is thus feasible that the passage is configured to be circular and the diameter is selected so that merely one finger passes through the passage. However, angular forms of the passage are also feasible and possible. The longer the passage is selected to be in the longitudinal direction and the narrower it is perpendicular to the longitudinal direction, the lower the probability of the container being opened unintentionally. The securing element can be configured to be hollow to avoid it having too high weight despite the high wall thickness.

In order to improve the handling of the securing element and prevent a user receiving cut wounds when gripping through the passage, the passage can have edges having a chamfering or rounding.

In addition to the function of preventing a random opening of the container, the securing element can furthermore simplify the closing of the container. For this purpose, it is provided that the securing element has an edge zone which projects over the centre piece perpendicular to the longitudinal axis. The edge zone can in particular be directed at an angle to the edge-side holding means of the closing element. In this case, the edge zone is preferably configured so that it has a closing member, in particular an edge, a slope, a projection or a rounding. The closing member can be directed towards an inner side of the securing element, which points towards the closing element and at least abuts against at least one part of the holding means. In a first alternative, the holding means are contacted by the closing member at the principal surfaces of the holding means at which the holding means form the angle α with respect to the centre piece. A pressure is now exerted on the securing element in the direction of the longitudinal axis and at the same time in the direction of the container. Since the principal axes and the direction of the applied pressure are aligned obliquely with respect to one another, a part of the applied pressure acts substantially perpendicularly to the longitudinal axis. As a result, the holding means move in the direction of the container so that the closing element closes the container. A pressure exerted by the user, in particular perpendicular to the longitudinal axis, directly on the holding means is therefore no longer necessary, i.e. merely a pressure in the direction of the longitudinal axis is sufficient for closing the container. The edge zone with the closing member should still remain in contact with the holding means during the movement and also thereafter to allow an opposite movement of securing element to the holding means.

In a second alternative, a plurality of, preferably three, holding means are bent outwards. These outwardly bent holding means are subsequently designated as closing means. The closing means now lie with their principal surfaces substantially on a plane with the centre piece. The securing element abuts against the closing means with its edge zone. For closing the container the user now exerts a pressure on the securing element merely in the direction of the longitudinal axis and at the same time in the direction of the container. Due to the pressure, the closing element now goes over into its first position so that the holding means enter into a form fit with the counter-holding means. In this alternative, no pressure is exerted on the holding means but the holding means enter into the form fit merely by transfer of the closing element from one secured position into the other. The closing means can be shortened in their length in relation to the holding means.

In embodiments of the securing element, it is possible to bring the closing element into the second position merely by a pressure on the actuation zone. This also includes embodiments in which the edge zone abuts against the holding means with a closing element. In order that a pressure only needs to be applied to the actuation zone for opening the container, in these embodiments the edge zone only contacts the holding means in a very limited extent, i.e. with a small contact surface and/or far from the centre piece. The holding means which move outwards due to the transition of the closing element from the one into the other secured position thus have a sufficiently large torque to move the securing element upwards. In addition, the securing element is of such low weight and connected to the closing element so flexibly and with such low adhesive and sliding friction that the securing element can easily be lifted by the holding means on transition to the second position. It is therefore not necessary for the user to lift the securing element on opening the container. An extensive contact surface of the edge zone on the holding means and/or a contact surface in the vicinity of the centre piece are not provided according to the invention. If the edge zone merely abuts against the closing means, no contact of the edge zone of the holding means takes place for closing the container and the transition into the second position is also easily possible.

In order that the securing element can fulfil its function and transmits no pressure to the centre piece of the closing element, it should comprise a relatively hard material, in particular hard rubber, plastic, wood or metal. With regard to plastic, thermosetting plastics, polyethylene terephthalate, high-density polypropylene or polypropylene polyurethane, PMMA (Plexiglas) etc. are feasible. Light metal alloys can be used as metal. The securing element can in particular be a sheet metal stamped part. The surface of the securing element pointing away from the container is exceptionally suitable for presenting packaging information, advertising material, logos or the like. These elements can, for example, be printed on, engraved, lasered and/or glued on.

It must also be ensured that the closing element can adopt its two positions with a concave or convex curvature of the centre piece and nevertheless remain connected to the securing element. As a result, it is obtained as a further property that the securing element is disposed on the closing element in such a manner that the centre piece and the holding means can be moved relative to the securing element. As a result, both the securing function of the securing element and the closure mechanism of the closing element can be reconciled with one another.

The relative mobility with respect to one another thus requires special types of fastening. Thus, it is feasible that the securing element encloses the closing element, wherein in particular a slight play is provided between securing element and closing element. To this end, the edge zone can surround or embrace the holding means so that the closing element is held or fastened on or in the securing element. In this case, the edge zone is bent so far inwards under the holding means that the edge zone reliably prevents the closing element from falling out even in the first position. The securing element at the same time provides a space which is configured in such a manner that the holding means can move into the second position. To this end the edge zone has a curvature. Alternatively, the edge zone can comprise the closing means. In order to arrange the securing element on the closing element, the securing element is inverted over the closing element or the closing element is tilted into the securing element, where the holding means and/or closing means briefly move inwards and thus enable the arrangement. As a result of their elasticity, however, the holding means and/or closing means move outwards again and thus enable the securing element to be permanently arranged on the closing element. Any falling out of the closing element from the securing element is prevented. In order to allow some play between edge zone and holding means or closing means, the edge zone is somewhat longer than the holding means or closing means.

It can be provided as a further type of fastening that the securing element on the inner side is fastened by at least one fastening element to the closing element. In this case, the fastening element can be arranged on the centre piece, in particular on its outer circumferential edge. In both positions of the closing element, the greatest curvature exists in the area of the actuation zone, i.e. relatively centrally. At the outer circumferential edge of the centre piece, on the other hand, the deflecting movements are small. It is therefore appropriate to arrange the fastening element in this area.

Even if the relative movements at the outer circumferential edge of the centre piece are smaller than at the centre, these must nevertheless by compensated by a fastening means. Therefore, an elastic material, in particular a double-side adhesive tape provided with foam can serve as fastening means. In the first position I, the securing element and the closing element are closer than in the second position II, in which case the centre of the centre piece, in particular the actuation zone, makes the largest relative movement to the securing element during a change of position. The foam is accordingly somewhat compressed in the first position I and relaxed in the second position II without the adhesive tape being detached from the securing element or the closing element. It is also feasible that the foam is relaxed in the first position I and pulled apart to some extent in the second position II. The relative movement at the outer circumferential edge of the centre piece where the fastening means are to be provided is fundamentally very small, e.g. less than 1 or 0.1 millimetre.

As an alternative, the fastening element can be at least one pin with a head which is attached to the securing element. In this case, the closing element has a hole through which the pin is guided, the pin being moveable through the hole. The length of the pin is determined so that a movement of the closing element is not impaired by the two ends of the pin, the securing element or the pin head.

As a further possibility, the fastening means can be configured to be hinge-like, it being configured in particular as an injection-moulded film hinge which has resilient properties. One hinge end is connected to the securing element, the other end is connected to the closing element. The relative movement of securing element and closing element is made possible by the hinge movement during the position change (of the click-clack element). If the closing element is made of plastic, this can comprise an injection-moulded film hinge. In this case, the securing element and the closing element are produced integrally, e.g. by a 2K plastic injection moulding process.

The securing element can be glued, plugged, screwed or riveted to the closing element on the outermost circumferential edge.

For aesthetic reasons, in the case of a fastening by a fastening element, the edge zone of the securing element can be extended beyond the closing element to completely cover the holding means, in which case the securing element must again provide sufficient space for the holding means in the second position.

Although a “click-clack” can is usually available as a sweets can in the trade, the closure mechanism can also be applied to other cans or other containers. Example here are containers for shoe cream, makeup, skin cream, cigarettes, cigars, refreshing wipes or drinks. The container can also be a bottle. It is also feasible that the container substantially comprises glass, porcelain, plastic, metal, wood or the like.

In order to be able to detect a first usage of the container, for example, in the area of food packagings, the passage of the securing element according to the invention can initially be closed with a tamper-evident closure. The tamper-evident closure can also function well as an advertising medium. For example, a paper or a film can lie over the passage as a tamper-evident closure and be firmly glued to the securing element. When using for the first time, the user must firstly pierce the paper or the film in order to exert a pressure on the actuation zone located thereunder and thus be able to open the container. The first use is clearly visible from the resulting torn paper. Alternatively, the paper or the film can be pulled off. The first use is then detectable from the missing paper or missing film. Alternatively, a lid made of plastic or metal which lies in the passage and therefore under the actuation zone, can be fastened to the securing element by means of thin webs and serves as a tamper-evident closure. In this case, a seamless or positive connection is feasible. When using for the first time, a user must exert so much pressure or pull that the thin webs are separated before he can open the container. Evidence of the first use is possible by means of the separated webs and/or the absence of the lid. In the case of a positive connection of the webs to the securing element, the form fit can be eliminated for the first opening, in which case the first use can merely be detected by the absence of the lid. It is also feasible that the thin webs on the lid do not break or should not break when the tamper-evident closure is removed. However, in this case the tamper-evident closure cannot be inserted into the passage again since the webs stand blocking the way and prevent this. It is therefore no longer possible to mount the lid or the tamper-evident closure.

Hitherto, it was not possible to use “click-clack” cans for liquids because in “click-clack” cans, no pressure or only insignificant pressure is exerted on the edge of the lateral surface of the container by the closing element. Thus, no seal can be used which only presses against the edge of the container due to an external pressure. However, a newly developed seal which is pressed against the inner lateral surface of the container by a pressure acting in the interior of the container can be used. For this purpose, the seal which is configured as a sealing element in particular has a sealing lip provided at the edge. This sealing lip projects into the container and due to its elastic deformation comes to abut against the inner lateral surface of the container over its full circumference. Thus, one embodiment according to the invention provides that the inner surface of the centre piece has a seal, wherein in particular the seal is fastened to the centre piece by a retaining plate. By this means it is also possible to package liquids in “click-clack” cans. It is further feasible to additionally provide a valve on the closing element. In this case, this can comprise an excess pressure valve or a drain valve. The valve can be disposed in the actuation zone. By this means the valve can be actuated simultaneously when opening the container so that an excess pressure inside the container can be reduced.

As a further embodiment, the securing element can be configured such that the container also rests with the securing element when the container is located in its lateral position in which its opening is pointing to one side. If the container is a bottle or upwardly tapering can, the bottle or can neck does not lie on a plane on which the container is located in the lateral position. As a result, the container tends to tilt. The securing element can project so far beyond the container neck perpendicular to the longitudinal axis that it comes to rest on the plane and thereby imparts stability to the container in the lateral position. If the securing element has an angular, in particular hexagonal or octagonal external contour, any rolling away of the container in the lateral position can be reliably avoided.

The invention also comprises a container having a closing element according to the invention and/or a securing element according to the invention. Furthermore, a method is provided for opening a container having a closing element as described above, which substantially corresponds to a “click-clack” closure. The container is opened in this case whereby a pressure is exerted exclusively through a passage of the securing element. Optionally, the closure of the container can also only be effected by a pressure on the securing element when the securing element is fitted with a correspondingly configured edge zone.

### BRIEF DESCRIPTION OF THE DRAWINGS

Further preferred exemplary embodiments of the invention are set out hereinafter with reference to the appended drawings and the following description. The exemplary embodiments are exemplary and not shown true to scale.

In the figures:

FIG. 1 shows a section through a container having a closing element and a securing element in a first position I in which the closing element closes the container,

FIG. 2 shows a section through a container having a closing element and a securing element in a second position II in which the closing element releases the container,

FIG. 3 shows a section through a container in a side position,

FIG. 4 shows a section through a securing element and a closing element, wherein the left half shows the second position II and the right half shows the first position I and

FIG. 5 shows a section through a container having a closing element and a securing element in a first position I in which the closing element closes the container,

FIGS. 6, 7, and 8 show a section through a closing element with a securing element in the second position, a further exemplary embodiment of the invention being depicted in each case,

FIG. 9 shows a section through a closing element with a securing element wherein a first exemplary embodiment of a tamper-evident closure is provided on the securing element,

FIG. 9a shows a plan view of the tamper-evident closure from FIG. 9,

FIG. 9b shows a view from below of the tamper-evident closure from FIG. 9,

FIG. 10 shows a section through a securing element with a second exemplary embodiment of a tamper-evident closure

FIG. 10a shows a plan view of the securing element from FIG. 10.

### DETAILED DESCRIPTION

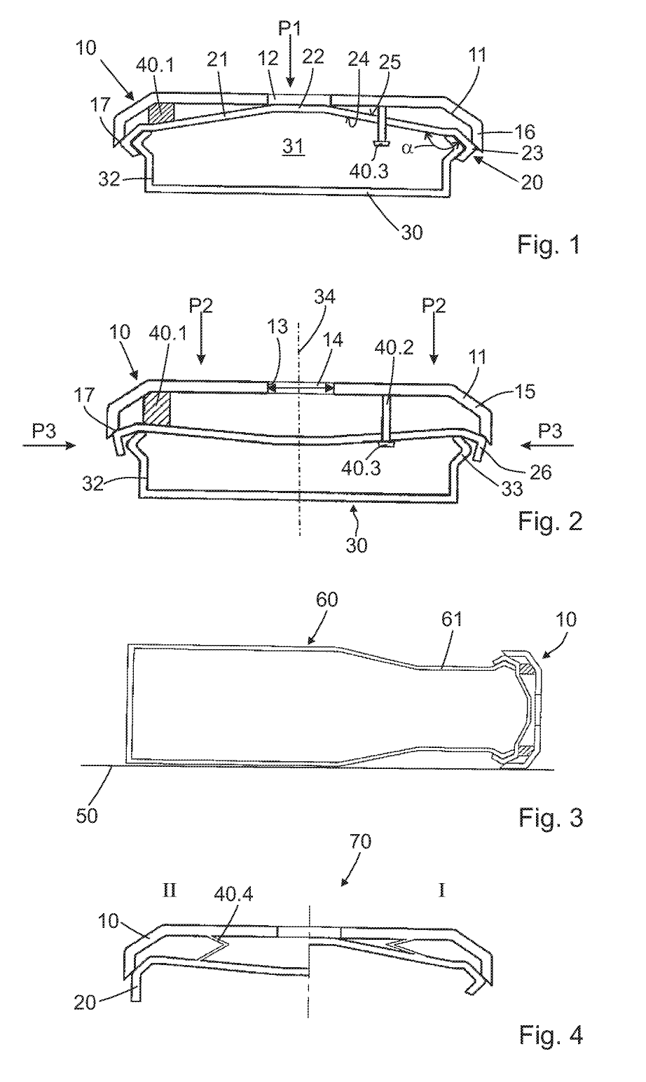

FIGS. 1 and 2 each show the same container 30 with the same closing element 20 and the same securing element 10 once in a closed state (FIG. 1) and in a state in which the closing element 20 only rests on the container 30 and releases it (FIG. 2). For clarity the reference numbers are not always shown in both figures; however they are applicable to both figures.

In this exemplary embodiment the container 30 is a round can, for example, for sweets. The container 30 has an upwardly pointing opening 31 and a circumferential lateral surface 32. The lateral surface 32 is configured with a circumferential projection 33 as counter-holding means. A longitudinal axis 34 is defined by the shape of the can. The container 30 is closed by the closing element 20. The closing element 20 in this case duplicates the basic shape of the container 30 and is therefore substantially circular in the present case. The closing element 20 has a centre piece 21 with a central actuation zone 22 and holding means 23 disposed at the edge on the centre piece 21. In the first position I, an inner surface 24 of the centre piece 21 points towards the container 30 and an outer surface 25 points away from the container 30. Only two of the holding means 23 are shown in FIGS. 1 and 2. However, these surround the centre piece 21 with a type of crenellation so that the holding means 23 are each disposed at the outer edge of the centre piece 21 separated by a distance from one another. In this case, the holding means 23 are angled at an angle α in the direction of the inner surface 24. In this case, the angle α is about 120°, the figures showing the important characteristics for the mechanism in an exaggerated manner. In reality the angle α is therefore about 90°. Each holding means 23 is in turn angled at its end 26 in the direction of the inner surface 24, where this angle can also be very variable. The centre piece 21 covers the opening 31 of the container 30.

In the first position I, which can be seen in FIG. 1, the centre piece 21 is curved in the direction of the longitudinal axis 34 away from the container 30 so that when viewed from the inner surface 24 of the centre piece 21, a concave curvature is formed. The curvature is shown exaggerated in the figure. In this position, the angled ends 26 of the holding means 23 form a form fit with the projection 33. Thus, unlike other containers, the container 30 cannot usually be opened when tension is exerted on the closing element 20 in the direction of the longitudinal axis 34. In order to improve the holding effect of the closing element 20, it is recommended in relation to the first position I to bend or angle the open end of the holding means 23 in an upward direction perpendicular to the longitudinal axis 34 or somewhat beyond this so that slippage of the holding means 23 on the projection 33 of the container 30 becomes impossible. However, for this the projection 33 should be configured to be rectangular or sharp-edged. Due to the previously described embodiment of the invention, particularly good holding forces can be achieved between closing element 20 and container 30 or particularly large tensile forces must act on the closing element 20 so that this can be withdrawn from position I against the existing form fit of holding means 23 and projection 33 or so that said element can be removed from the container 30.

In FIG. 1 the securing element 10 is disposed above the closing element 20 and is substantially adapted to the shape of the closing element 20, i.e., substantially circular in this exemplary embodiment. In this case, the securing element 10 is provided with a passage 12 at the centre of its circular configuration, through which the section was taken. Due to its rigid configuration, the securing element 10 protects the closing element 20 from a surface pressure which is exerted from outside in the direction of the container 30. Only a pressure exerted in a punctiform manner through the passage 12 can reach the actuation zone and thereby effect the opening of the container 30. The passage 12 can be so long with its longitudinal side 13 along the longitudinal axis 34 and so narrow in its diameter 14 that an unintentional pressure (see arrow P1) is very unlikely. The outer circumferential edge 15 of the securing element can be arbitrarily shaped, in particular angular, as already described previously, and is bevelled in this case.

By means of a pressure (see arrow P1) on the actuation zone 22 in the direction of the longitudinal axis 34 and in the direction of the container 30, the container 30 is released (see FIG. 2). The centre piece 21 is curved in the direction of the container 30. When viewed from the inner surface 24 of the centre piece 21, this corresponds to a convex curvature. The centre piece 21 hereby changes from one secured, low-stressed position into the other. At the same time, the holding elements 23 move away from the container 30 and release the projection 33. By this means the closing element 20 can now be released from the container 30, easily and without force, in particular without applying tension. Since the securing element 10 abuts against the holding means 23, the securing element 10 is easily displaced upwards by the pivoting movement of the holding means 23. At the same time, the centre piece 21 has moved downwards so that in the released state in FIG. 2 a maximum distance is obtained between the securing element 10 and the centre piece 21. This is shown schematically exaggerated in FIG. 2. In contrast, due to the opposite curvature and the depressed state of the securing element 10 in FIG. 1, a minimal distance is achieved between the securing element 10 and the centre piece 21, in particular the actuation zone 22. It is likewise feasible that the maximum distance between the securing element 10 and the centre piece 21 is achieved in the first position I whilst the shortest distance between the securing element 10 and the centre piece 21 is achieved in the second position II.

The fastening elements 40 must take into account this relative movement or enable this. As an example, FIGS. 1 and 2 show two different exemplary embodiments left and right for the fastening means 40. Usually only identically constructed fastening means 40 are used in practice for a closure device 70 comprising a securing element and a closing element connected thereto. Shown as an example on the one hand is a double-sided adhesive tape 40.1 which is fastened with one side to the outer surface 25 of the centre piece 21 and with the other side to the inner side 11 of the securing element 10. At its centre the adhesive tape has an extensible foam and can therefore stay fastened to both elements despite the relative movement of securing element 10 and closing element 20. As a second exemplary embodiment a pin 40.2 is shown as a fastening means. The pin 40.2 is attached to the inner side 11 of the securing element 10 and is guided through a hole on the centre piece 21. Located at its end is a head 40.3 which preserves the pin 40.2 from sliding out and serves as a stop. The length of the pin 40.2 must be determined so as to ensure a sufficient relative movement of securing element 10 and closing element 20. In FIG. 2 in which the two elements have the maximum distance from one another, the pin 40.2 abuts with its head 40.3 against the inner surface 24 of the centre piece 21.

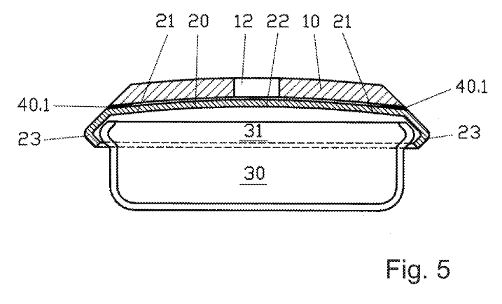

FIG. 4 shows a hinge 40.4 as a further fastening means 40. This is fastened with its one end to the inner side 11 of the securing element 10 and with its other end to the outer surface 25 of the centre piece 21. As a result of its hinge movement, said hinge compensates for the relative movement, the hinge 40.4 being hinged further apart in the second position II (left side in FIG. 4) than in the first position I (right side in FIG. 4). The fastening means 40 are located remotely from the actuation zone 22 since the largest relative movement takes place in the vicinity of the actuation zone 22. Overall, the order of magnitude for the relative movement in practice is only in the millimetre range. The fastening means 40 shown in FIG. 1, FIG. 2, FIG. and FIG. 5 serve to illustrate the various possible solutions and variants of the invention. Naturally the respective fastening means 40 can each be provided alone or in combination in a securing element 10.

If the container 30 is to be reclosed again and thus transferred from the state in FIG. 2 again to the state in FIG. 1, a pressure (see arrow P3) would be exerted on the holding means 23 perpendicular to the longitudinal axis 34 without the securing element 10. As a result the holding means 23 move perpendicular to the longitudinal axis 34 in the direction of the container 30 and grasp the projection from behind. The centre piece 21 also changes its secured position so the closing element 20 again enters into its first position I. The securing element 10 makes a more elegant closure technique possible. To this end the securing element 10 has an angled edge zone 16 in the direction of the holding means 23. This is preferably fitted with a closing member 17 configured as a slope, the slope pointing towards the inner side 11 of the securing element 10. With the slope as closing member 17, the securing element 10 abuts against the holding means 23 in such a manner that an angle is formed between the edge zone 16 and the holding means 23. If the securing element 10 is now pressed in the direction of the longitudinal axis 34 and in the direction of the container 30 (see arrow P2), due to the geometrical arrangement a part of the pressure acts perpendicularly to the longitudinal axis 34 and the holding means 23 are pressed onto the container 30.

FIG. 3 shows a further example of a container 30 in the form of a bottle 60. This is resting in a lateral position on a plane 50. In this case, the securing element 10 projects so far away from the bottle neck 61 that it also rests on the plane 50 and stabilises the lateral position of the bottle 60. The container 30 can also form a storage can, a drinks can, a cooking pot or the like.

FIGS. 1 to 4 shows a fundamental variant of the securing element 10 which is configured with an angled circumferential edge 15 and/or and angled edge zone 16 in order to be able to simply close the container 30 via the securing element 10, in which a perpendicular pressure (see arrow P2) serves to (as already described above) ensure that the holding means 23 of the closing element 20 positively grips the projection 33 from behind. Accordingly, the closing element is in its first position I.

FIG. 5 shows a further fundamental variant to the securing elements 10 from the previous FIGS. 1 to 4. The securing element 10 shown in FIG. 5 has the same security effect as the securing elements 10 shown previously from FIGS. 1 to 4. However, the securing element 10 from FIG. 5 lacks the angled circumferential edge 15 with the adjoining likewise angled edge zone 16 which cooperates with the holding means 23 during a position change from II to I. Consequently, a pressure (see arrow P2) on the securing element 10 causes no change of the second position II into the first position I of the closing element 20 since the securing element 10 specifically does not cooperate with the holding means 23 of the closing element 20. The securing element 10 itself can be glued, plugged, screwed, riveted, welded or the like on the closing element 20, e.g. by means of the fastening means 40.

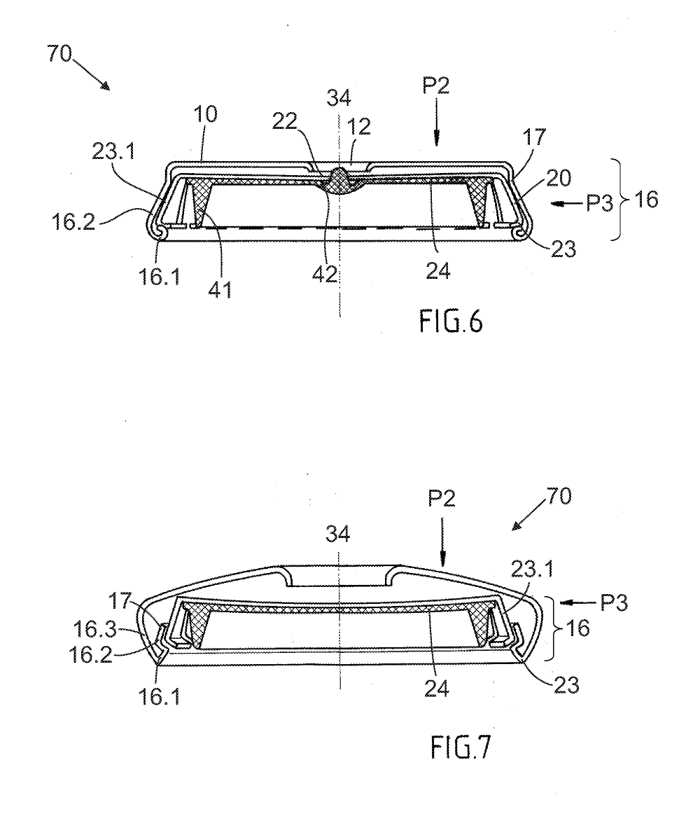

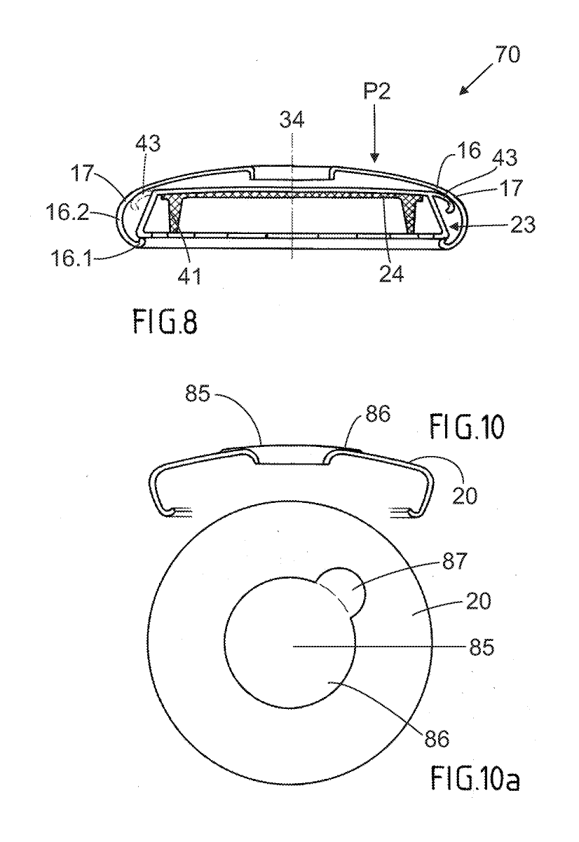

FIGS. 6 to 8 each show a further exemplary embodiment of a securing element 10 according to the invention with a closing element 20, wherein the securing element together with the closing element 20 forms a closure device 70. The securing elements 10 shown in FIGS. 6 to 8 have no fastening elements 40 but the closing element 20 is hindered from falling out from the securing element 10 by the edge zone 16 gripping below the holding means 23. For this purpose the edge zone 16 has an inwardly bent part piece 16.1. FIGS. 6 to 8 each show the second position II of the closing element 20 in which the holding means 23 project radially outwards. However, the part piece 16.1 is bent so far inwards that the holding means 23 are embraced by the part piece 16.1 even in the first position I so that even in the first position I the closing element 20 is held securely on the securing element 10. The securing element 10 has a curvature 16.2 so that a space is formed into which the holding means 23 can project in the second position II. In FIGS. 6 and 8 the part piece 16.1 corresponds to the end of the edge zone 16 wherein in FIG. 7 the end of the edge zone 16 is formed as closing member 17. Furthermore, FIGS. 6 to 8 each show a seal 41 for sealing an inner space of the container 30 which is disposed on the inner surface 24. In FIG. 6 the seal additionally has a valve 42 projecting through the actuation zone 22. For this purpose the actuation zone 22 is interrupted.

FIGS. 6 to 8 differ in the type of closing member 17. In FIG. 6 the closing member 17 is configured as a projection of the edge zone 16. For this purpose the edge zone 16 has an inwardly directed kink which cooperates mechanically with the holding means 23. In FIG. 7 the closing member 17 is configured as an edge and at the same time as the end of the edge zone 16. If the edge zone 16 in FIG. 7 is followed from top to bottom, the edge zone 16 initially forms a smooth, visually pleasing sleeve 16.3, thereafter part piece 16.1 is formed for holding the closing element 20, thereafter again the curvature 16.2 whilst the closing member 17 is located at the end of the edge zone 16. By this means it is achieved that curvature 16.2 and closing member 17 are not visually accessible to an observer. Both in FIG. 6 and in FIG. 7 the closing member 17 abuts against principal surfaces 23.1 of the holding means 23. If the user both in FIG. 6 and in FIG. 7 exerts a pressure in the direction of the arrow P2 onto the securing element 10, as a result of the closing member 17 a part of the pressure acts perpendicularly to the longitudinal axis 34 according to arrow P3 and the closing element 20 moves into the first position I (not shown).

FIG. 8 shows some holding elements 23 which are outwardly curved and therefore configured as closing means 43 of which one is visible in FIG. 8 and one is indicated. Preferably at least three holding means are configured as closing means, which occupy an angle of 120° between each another. The securing element 10 abuts with its edge zone 16 from outside against or on the closing means 43, the closing member 17 being formed as a rounding of the edge zone 16. If a user exerts a pressure on the securing element 10 according to the arrow P2, the closing member 17 merely acts on the closing means 43, whereby the closing element 20 moves into the first position. At the same time, the closing means 43 can also serve as fastening elements 40 between the securing element 10 and the closing element so that the securing element 10 is fastened to the closing element 20 by the closing means 43.

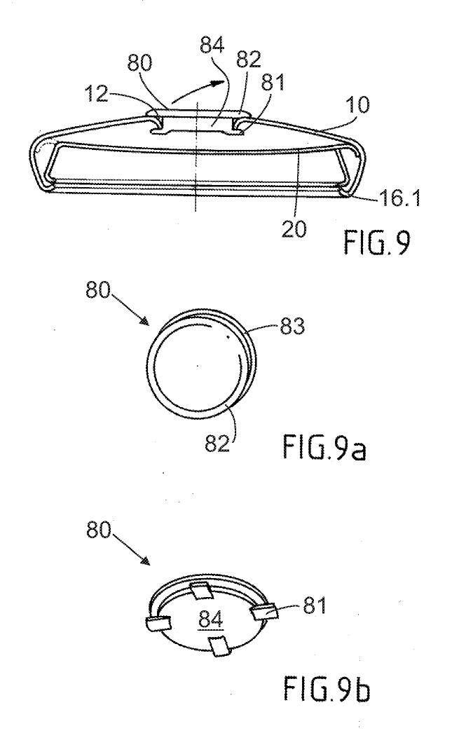

FIG. 9 again shows an exemplary embodiment of the securing element 10 from FIG. 8. A tamper-evident closure is additionally shown in the passage 12. In this case, the tamper-evident closure is configured as a lid 80 which is fastened positively on the securing element 10 by webs 81 and a folded edge 82. In this case, the webs 81 and the folded edge 82 enclose the passage 12 at the top and at the bottom. As shown in the plan view of the lid 80 in FIG. 9a, the lid 80 has a clip 83 at the side which initially rests on the securing element 10. A user can now raise the clip 83 to some degree and remove the lid 80 from the securing element 10. In so doing, the webs 81 which have appropriate predetermined breaking points, break away. Alternatively the webs 81 and/or a main body 84 of the lid 80 are overall formed so flexibly that the lid 80 can be removed together with the webs 81. The user identifies from the missing lid 80 that the container 30 must have been opened already. FIG. 9b shows the lid 80 with the webs 81 from obliquely below, four webs 81 being fastened to the lid 80 for example. However, three or more than four webs 81 can also be provided.

In FIG. 10 the tamper-evident closure is configured as a film 85 which lies over the passage 12 and is materially bonded to the securing element 10 at a side region 86. FIG. 10a shows a plan view of the securing element 10 from FIG. 10. Here it can be seen that the film 85 has a tab 87 which is not directly fastened to the securing element 10. A user can lift the tab 87 and pull the film 85 from the securing element 10. The film 85 which can be configured as a paper seal can also be provided with predetermined breaking points, in particular in the central region, so that this is easy to press through (in the passage 12) and be destroyed.

The invention is not restricted to the exemplary embodiment shown but also comprises further variants as mentioned in the description and in the claims. Likewise, as described, pressure- and fluid-tight containers can also be created if the aforementioned sealing element 41 is used in the closure device 70.

1. A securing element for a closing element, wherein the closing element is configured to have a center piece which comprises an actuation zone and holding means, wherein the closing element closes an opening of a container which has a longitudinal axis, in a first position and releases it in a second position, wherein in the first position the holding means enter into a form fit with the container and wherein the closing element can be brought from the first into the second position (I, II) by a pressure acting on the actuation zone in the direction of the container so that the holding means release the form fit,
wherein
the closing element is disposed between the securing element and the container in the first position and the securing element has a passage which is substantially disposed above the actuation zone and a pressure can only be exerted on the actuation zone through the passage.

2. The securing element according to claim 1,
wherein
the passage is configured to be long in the direction of the longitudinal axis and/or is of small spatial dimensions perpendicular to the longitudinal axis.

3. The securing element according to claim 1,
wherein
the securing element has an edge zone which is directed at an angle to the holding means.

4. The securing element according to claim 3,
wherein
the edge zone has a closing member, comprising an edge, a slope, a projection or a rounding.

5. The securing element according to claim 3,
wherein
the securing element abuts against closing means of the closing element, wherein the closing means are formed by a part of the holding means being bent outwards and wherein in particular the securing element abuts against the closing means internally on the edge zone.

6. The securing element according to claim 3,
wherein
the edge zone, with the closing member, abuts against the holding means or closing means in such a manner that the closing element can be brought from the second into the first position by a pressure of a user on the securing element in the direction of the longitudinal axis.

7. The securing element according to claim 1,
wherein
the securing element comprises hard material comprising at least one of hard rubber, plastic, wood, metal, and sheet metal.

8. The securing element according to claim 1,
wherein
the securing element is disposed on the closing element in such a manner that the center piece and the holding means can be moved relative to the securing element.

9. The securing element according to claim 3,
wherein
the securing element embraces the holding means and/or the closing means with a part piece of the edge zone so that the closing element is disposed permanently on the securing element.

10. The securing element according to claim 9,
wherein
the edge zone has a curvature so that the holding means can be moved into the second position.

11. The securing element according to claim 1,
wherein
the securing element is fastened on an inner side of said securing element by at least one fastening element to the closing element, wherein in particular the fastening element is disposed in the area of the outer circumferential edge of the center piece.

12. The securing element according to claim 1,
wherein
a tamper-evident closure is disposed above or in the passage to identify a first opening of the container on the securing element.

13. The securing element according to claim 1,
wherein
the side of the center piece pointing towards the container in the first position has a seal, wherein the seal is fastened by a retaining plate on the center piece.

14. A container having a closing element and a securing element according to claim 1.

15. A method for opening a container having a closing element, wherein the closing element is configured to have a center piece which comprises an actuation zone and holding means, wherein the closing element closes an opening of a container which has a longitudinal axis, in a first position and releases it in a second position, wherein in the first position the holding means enter into a form fit with the container and wherein the closing element is brought from the first into the second position by exerting a pressure acting on the actuation zone in the direction of the container so that the holding means release the form fit,
wherein
the pressure is only exerted through a passage of a securing element.

16. The method according to claim 15,
wherein
it is operated with a securing element wherein the closing element is configured to have a center piece which comprises an actuation zone and holding means, wherein the closing element closes an opening of a container which has a longitudinal axis, in a first position and releases it in a second position, wherein in the first position the holding means enter into a form fit with the container and wherein the closing element can be brought from the first into the second position (I, II) by a pressure acting on the actuation zone in the direction of the container so that the holding means release the form fit, wherein the closing element is disposed between the securing element and the container in the first position and the securing element has a passage which is substantially disposed above the actuation zone and a pressure can only be exerted on the actuation zone through the passage.
